(19) United States
(12) Patent Application Publication
(10) Pub. No.: US 2017/0070402 A1
(43) Pub. Date: Mar. 9, 2017

(54) System and Method for Generating an Automated Customized Report in Information Technology Service Delivery Environment

(71) Applicant: HCL Technologies Limited, Uttar Pradesh (IN)

(72) Inventors: Aditya Garg, Uttar Pradesh (IN); Shailender Singh, Uttar Pradesh (IN); Sanyog Garg, Uttar Pradesh (IN); Arjun Majumdar, Uttar Pradesh (IN)

(21) Appl. No.: 15/215,687

(22) Filed: Jul. 21, 2016

(30) Foreign Application Priority Data
Sep. 8, 2015 (IN) 2817/DEL/2015

(51) Int. Cl. H04L 12/24

(52) U.S. Cl. CPC H04L 41/5032; H04L 41/5074; H04L 41/5064

(57) ABSTRACT

The present subject matter discloses system and method for generating an automated customized report in service delivery environment. Data is received from plurality of sources, wherein the data is associated to a plurality of activities being performed corresponding to one or more services defined by a service level agreement (SLA). Subset of data is fetched, from the data, corresponding to a set of activities. Further, one or more metrics is computed based on the subset of data. Further, the system analyze whether the set of activities are complying with the SLA based on the one or more metrics computed. Further, a report is generated based on the aforementioned analysis. The report generated is customized in a predefined format defined as per the SLA. The report generated is transmitted to a plurality of devices, of a plurality of concerned members, associated with the report.

### CROSS-REFERENCE TO RELATED APPLICATIONS AND PRIORITY

The present application claims benefit from Indian Complete Patent Application No. 2817/DEL/2015, filed on Sep. 8, 2015, the entirety of which is hereby incorporated by reference.

### TECHNICAL FIELD

The present subject matter described herein, in general, relates to a method and a system providing automation in generating a report in an Information technology (IT) service delivery environment.

### BACKGROUND

In an Information Technology (IT) service delivery environment, a huge amount of data is generated every day. The data comes from various sources like tools, monitoring systems, peoples, and processes. These data is quite important because it contain useful information pertaining to various activities being performed in the service delivery environment. To understand these various activities, it is important to process the data in a manner so that the useful information is presented in meaningful format.

However, collating such huge data in manner which makes sense is not an easy task. In known art, these data are manually downloaded from the various sources. Thus, lots of manual effort, time and cost is wasted in performing such activities. Even after downloading such huge data, it is not sure whether the downloaded data is compatible according to client's environment, for example, hardware and software configurations of the client' system.

Apart from these environmental requirements, the data has to be processed and analyzed according to the client's specific requirements/interest, which is again another concern. To make sense out of such huge data, a meaningful report has to be generated meeting the specific requirements of the client. But, due to the huge amount of the data and its variety, it is not feasible to meet the specific requirements of the clients.

### SUMMARY

This summary is provided to introduce aspects related to systems and methods for generating a customized report are further described below in the detailed description. This summary is not intended to identify essential features of subject matter nor is it intended for use in determining or limiting the scope of the subject matter.

In one implementation, a system for generating a customized report is disclosed. The system comprises a processor and a memory coupled to the processor. The processor may execute a plurality of modules stored in the memory. The plurality of modules may comprise a receiving module, a fetching module, a computing module, an analyzing module, and a generating module. The receiving module may receive data from a plurality of sources. The data received may be associated to a plurality of activities being performed corresponding to one or more services defined by a service level agreement (SLA). Further, the fetching module may fetch subset of data corresponding to a set of activities, from the plurality of activities, being performed for a predefined time interval. Further, the computing module may compute one or more metrics based on the subset of data. Further, the analyzing module may analyze whether the set of activities are complying with the service level agreement (SLA) based on the one or more metrics. Further, the generating module may generate a report based on the analysis. The report generated may be customized in a predefined format defined as per the service level agreement (SLA)

In another implementation, a method for generating a customized report is disclosed. The method may comprise receiving, by a processor, data from a plurality of sources. The data received may be associated to a plurality of activities being performed corresponding to one or more services defined by a service level agreement (SLA). The method may further comprise a step of fetching, by the processor, subset of data corresponding to a set of activities, from the plurality of activities, being performed for a predefined time interval. Further, the method may comprise a step of computing, by the processor, one or more metrics based on the subset of data. The method may further comprise a step of analyzing, by the processor, whether the set of activities are complying with the service level agreement (SLA) based on the one or more metrics. Further, the method may comprise a step of generating, by the processor, a report based on the analysis, wherein the report generated is customized in a predefined format defined as per the service level agreement (SLA).

Yet in another implementation a non-transitory computer readable medium embodying a program executable in a computing device for generating a customized report is disclosed. The program may comprise a program code for receiving data from a plurality of sources. The data received may be associated to a plurality of activities being performed corresponding to one or more services defined by a service level agreement (SLA). The program may further comprise a program code for fetching subset of data corresponding to a set of activities, from the plurality of activities, being performed for a predefined time interval. Further, the program may comprise a program code for computing one or more metrics based on the subset of data. The program may comprise a program code for analyzing whether the set of activities are complying with the service level agreement (SLA) based on the one or more metrics. Further, the program may comprise a program code for generating a report based on the analysis. Further, the report generated may be customized in a predefined format defined as per the service level agreement (S LA).

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for generating a customized report, in accordance with an embodiment of the present subject matter.

FIG. 2 illustrates the system, in accordance with an embodiment of the present subject matter.

FIG. 3 illustrates detail explanation of the system, in accordance with an embodiment of the present subject matter.

FIG. 4 illustrates an example of a report indicating open ticket dashboard, in accordance with an embodiment of the present subject matter.

FIG. 5 illustrates an example of a report indicating service desk performance dashboard, in accordance with an embodiment of the present subject matter.

FIG. 6 illustrates a method for generating the customized report, in accordance with an embodiment of the present subject matter.

### DETAILED DESCRIPTION

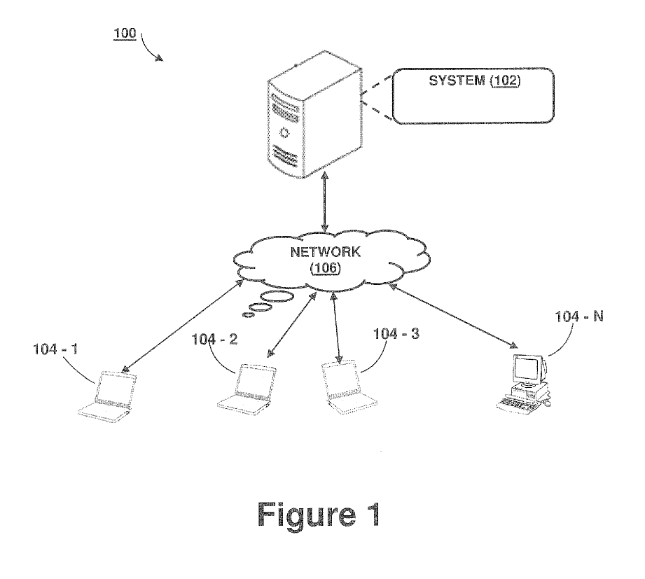

Referring to FIG. 1, a network implementation 100 of system 102 for generating a customized report is illustrated, in accordance with an embodiment of the present subject matter. Although the present subject matter is explained considering that the system 102 is implemented for generating the customized report on a server, it may be understood that the system 102 may also be implemented in a variety of computing systems, such as a laptop computer, a desktop computer, a notebook, a workstation, a mainframe computer, a server, a network server, a tablet, a mobile phone, and the like. In one embodiment, the system 102 may be implemented in a cloud-based environment. It will be understood that the system 102 may be accessed by multiple users through one or more user devices 104-1, 104-2, 104-3 . . . 104-N, collectively referred to as user 104 hereinafter, or applications residing on the user devices 104. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network 106 may include a variety of network devices, including routers, bridges, servers, computing devices, storage devices, and the like.

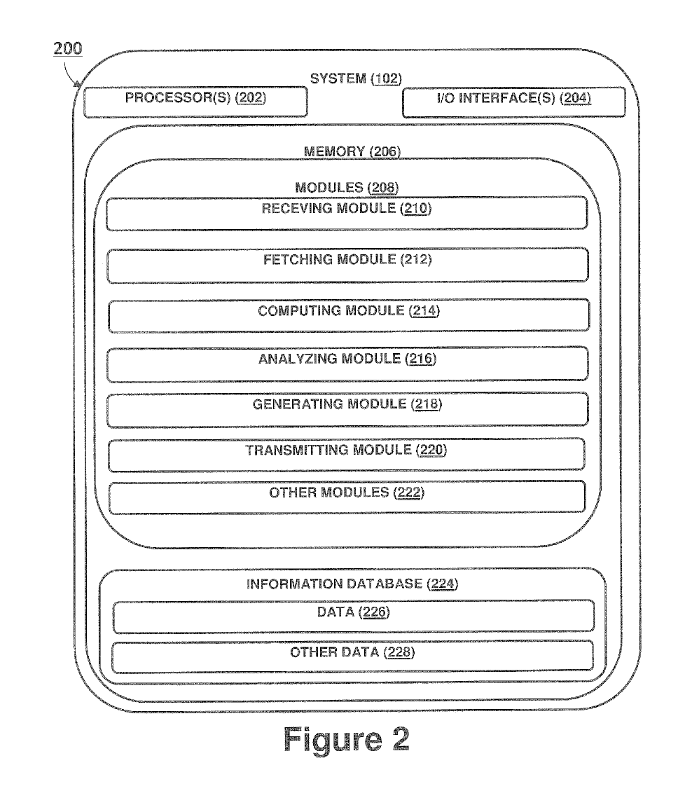

Referring now to FIG. 2, the system 102 is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions or modules stored in the memory 206.

The I/O interface 204 may include a variety of software and hardware interfaces, for example, a web interface, a graphical user interface, and the like. The I/O interface 204 may allow the system 102 to interact with a user directly or through the user devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, a compact disks (CDs), digital versatile disc or digital video disc (DVDs) and magnetic tapes. The memory 206 may include modules 208 and information database 224.

The modules 208 include routines, programs, objects, components, data structures, etc., which perform particular tasks or implement particular abstract data types. In one implementation, the modules 208 may include receiving module 210, a fetching module 212, a computing module 214, an analyzing module 216, a generating module 218, a transmitting module 220, and other modules 222. The other modules 222 may include programs or coded instructions that supplement applications and functions of the system 102.

The information database 224, amongst other things, serves as a repository for storing data processed, received, and generated by one or more of the modules 208. The information database 224 may also include data 226, and other data 228.

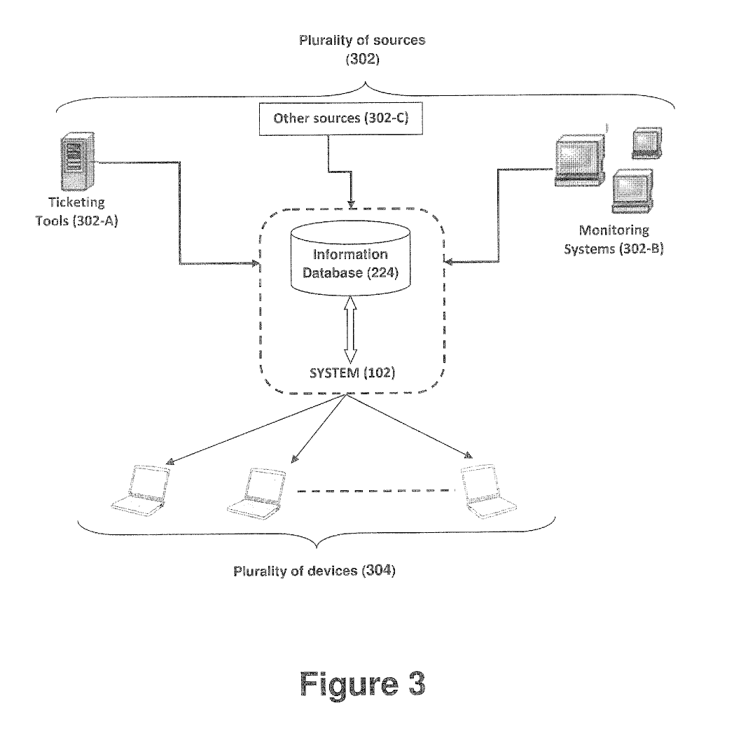

Referring now to FIG. 3 illustrating detail explanation of the system, in accordance with an embodiment of the present subject matter. In an information technology (IT) infrastructure service delivery environment, huge amount of data 226 is generated. These data 226 are mainly related to a plurality of activities being performed by agents/call center agents/human resources/monitoring tools and like corresponding to one or more services defined by service level agreement (SLA). The SLA may differ from one client/customer to another client/customer based on their requirements. In the SLA, specific requirements of the clients are noted as a contract. The requirements and the SLA are explained in detail in subsequent paragraphs of the specification.

Further, with the aforementioned IT infrastructure service delivery environment, web-based ticketing tools 302-A, monitoring systems 302-B and other types of sources 302-C are associated. The purpose of such tools, monitoring systems and sources (i.e., 302-A, 302-B, 302-C) is to generate the above discussed data 226 which is associated with the plurality of activities being performed by the by agents/call center agents/human resources/monitoring tools and like. According to the embodiments, all these tools, monitoring systems and sources may be collectively referred as a plurality of sources 302 for generating the data 226. Further, the plurality of sources 302 may also include Information Technology Service Management (ITSM) tools which may be customized or tailored specifically based on configuration (hardware & software) of plurality of devices 304 associated with plurality of concerned members. In one embodiment, the plurality of concerned members may be clients or customers.

Further, the data 226 generated, through the plurality of sources 302, is received by the receiving module 210 of the system 102. The data 226 is then processed and stored in the information database 224 of the system 102. However, according to other embodiments of present disclosure, the data 226 may be directly received in the information database 224 of the system 102. Thus, the receiving of the data 226 from the plurality of sources 302, either by the receiving module 210 or by the information database 224 automatically, eliminates a need for involving a human for such activities. Similar to the ITSM tools which are customized, the receiving of the data 226 is also customized, by the receiving module 210, based on the hardware configuration and software configuration of the plurality of devices 304 and the tools from which the data 226 is received. For example, if a tool is an Automatic Call Distributor (ACD) (i.e., call monitoring tool), the receiving module 210 customizes the receiving of the data 226 by using various languages like seculi (i.e., graphical user interface (GUI) automation tool), selenium, power shell, and excel Visual Basic for Application (VBA). Whereas, if the tool is a BMC Remedy, then the receiving module 210 customizes the receiving of data 226 by using only the excel VBA. In another example, if the tool is HP' s ServiceNow tool, then the receiving module 210 customizes the receiving of the data 226 using excel VBA and selenium only. Thus, based on details of these tools, the customization is done.

Once the data 226 is received and stored in the information database 224, the system 102 may process the data 226 in order to make sense out of such data 226. Here, the making sense means that the data 226 should be presented in such a manner so that the concerned members/concerned parties/customers/clients may take useful decisions as per their specific requirements or business needs. For doing this, in a first step, the fetching module 212 may fetch subset of data from the data 226 stored in the information database 226. The subset of data fetched may correspond to a set of activities, of the plurality of activities, being performed by the agents/call center agents/human resources/monitoring tools and like for a predefined time interval. As discussed in above sections of the specification, the set of activities are performed corresponding to the one or more services defined by the SLA, which may differ from one client to another client or from one concerned member to another concerned member.

For example, a client/concerned member X may be interested in getting details of Service A, Service B, Service C and Service D for a particular period/interval of time defined as per their SLA. Whereas, another client/concerned member Y may be interested in getting details only for Service A and Service B for a particular period/interval of time defined as per their SLA. Thus, based on such specific requirements, the fetching module 212 fetches the subset of data, from the data 226, corresponding to the set of activities. Along with the aforementioned services, one or more metrics are also defined in the SLAs. These metrics are nothing but key performance indicators (KPI) that demonstrates how effectively a company/call center is achieving business objectives. According to embodiments of present disclosure, the metrics may include, but not limited to, number of calls received, number of calls abandoned, average speed to answer the calls, average handling time, available time, auxiliary time and service level. For example, the average handling time (AHT) metric indicates a total amount of time related to calls, including average talk time (ATT) and average after call work time (ACW), divided by the number of calls handled. In another example, the service level metric measures ability to deliver a standard of service which is defined/agreed upon in the SLA.

Thus, based on the subset of data fetched (which is based on the specific requirements of the clients/concerned members) corresponding to the set of activities, the computing module 214 computes one or more metrics. But before computing the one or more metrics, one or more formulae of the one or more metrics are modified based on the specific requirements of the clients/concerned members. Thus, the computing module 214 computes the one or more metrics considering the one or more formulae modified based on the requirements. It must be understood from present context, that the set of activities indicates how well the agents/call center agents/human resources have handled the calls/call request or other type of request for a particular interval of time. For example, considering the metric “Service level”, if the standard as per the SLA says that 75% of the calls must be answered within 20 seconds, then the set of activities corresponding to such standard must be checked in order to monitor performance of the agents/call center agents/human resources.

Thus, in next step, in order to perform such check, the analyzing module 216 analyzes whether the set of activities are complying with the service level agreement (SLA) based on the one or more metrics computed. In contrast of above mentioned standard (i.e., 75% of the calls must be answered within 20 seconds), if the analyzing module 216 analyzes that only 65% of calls are answered within 20 seconds, then it must be understood that the agents/call center agents/human resources (performing the set of activities) are not following the standards defined in the SLA, and therefore, it is a breach of the SLA. This is because, there is a difference between the standard defined and actual activities done by the agents/call center agents/human resources. It must be understood to person skilled in art, that the aforementioned standard is just an example, and there may be different combinations of standards defined in the SLA as per the client's/concerned member's requirements.

The analysis performed in the above paragraph may be presented to the concerned members/clients for understanding different activities (existing and ongoing) in a service delivery environment. Thus, to present the above discussed analysis in a meaningful format, the generating module 218 generates a report. The report generated may be customized in a predefined format defined as per the service level agreement (SLA). The automation and the customization in the report generation are quite helpful in meeting the specific requirements of the concerned members/clients. According to embodiments of present disclosure, the report generated may comprise information pertaining to the one or more metrics upon which the set of activities are performed. The report may also comprise a priority list of open tickets based on the service level agreement (SLA). Further, the report generated may be transmitted automatically, by the transmitting module 220, to plurality of devices 304. The plurality of devices 304 may belong to the plurality of concerned members/clients associated with the report generated. Examples of the report generated are explained is subsequent paragraphs of the specification.

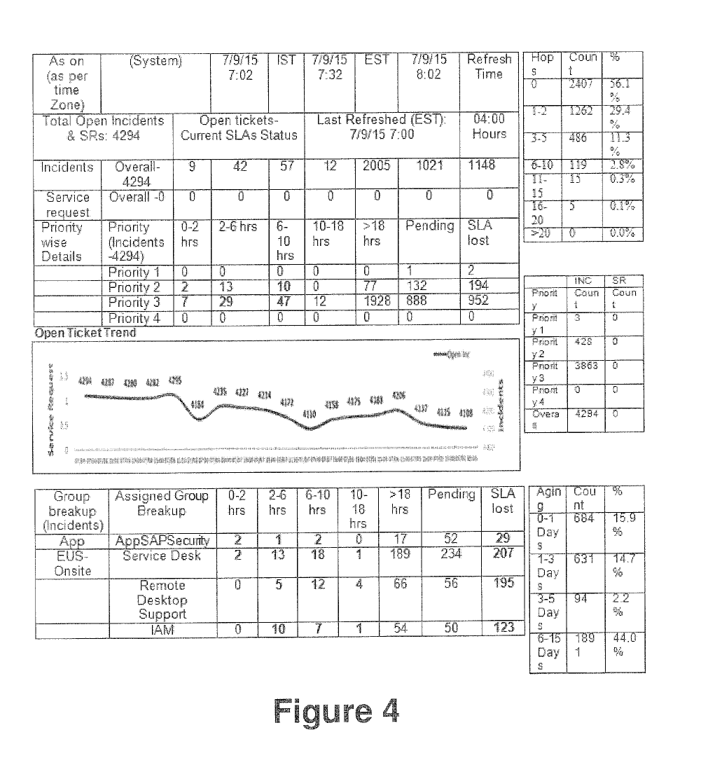

Now referring to FIG. 4 illustrates an example of a report indicating open ticket dashboard. FIG. 4 lists the counts of open tickets at a given point of time. These open tickets are segregated into different time buckets like 0-2, 2-6, 6-10, 10-18 and >18 hrs in order to prioritize the tickets as per the SLA remaining time (i.e., time left for a ticket to breach its SLA). Thus, the data is shown in the report as per criticality of the tickets. Further, automated notifications may be sent to one or more concerned persons (i.e., the person who is responsible for resolution of the ticket). The report also tracks few other key parameters like Hops and Aging. Both these key parameters have been shown in detail in right side of the report. The Key parameter “Hop” indicates transfers of the ticket. Whereas, another key parameter aging indicates how older the ticket is (i.e., ticket open since). The report also showcases the backlog trend to see whether the performance is improving or getting worse. Further, the report generates helps the team or the one or more concerned members in creating awareness about the ticket's current SLA status. However, it must be understood to a person skilled in art, that the automation in the report generation is not only limited to this report as shown in the FIG. 4, and further, there may be numerous such dashboards may be generated, according to embodiments of present disclosure.

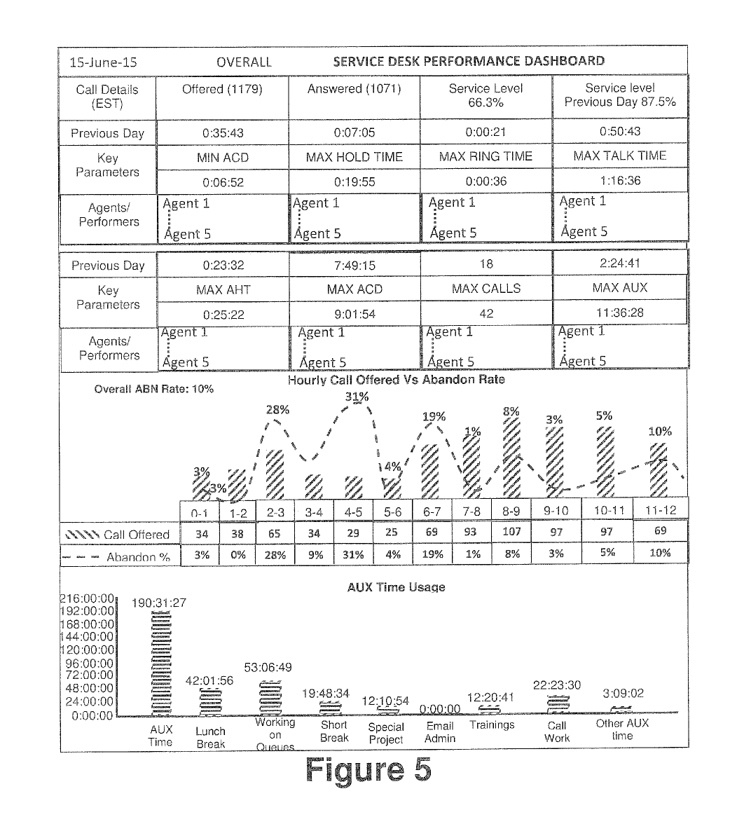

Now referring to FIG. 5 illustrates an example of a report indicating service desk performance dashboard. The service desk performance dashboard tracks different key performance indicators of the call taking agents (i.e., the call center agents/human resources). Further, the report also shows the performance of the entire team associated with the service delivery environment. Some of the key metrics are like Average Handling time (AHT), Service Levels, Aux time usage, availability of the agents and other key parameters is shown in the service desk performance dashboard. Also, the agents/performers, along with their names and other details, corresponding to the key performance indicators are displayed on the dashboard. These agents/performers may be a top five agents or bottom five agents. Further, the service desk performance dashboard also shows an hourly trend (Hourly Call Offered Vs Abandon Rate) of the call along with Abandon rate. This graph/trend helps the concerned members or authorities to take various decisions regarding the performance of the call agents or the teams. Average productivity of the entire team is also captured in the service desk performance dashboard. It must be understood to a person skilled in art that key performance indicators and trends shown in the service desk performance dashboard is just an example, and there be other combinations of key performance indicators and the trends which can be generated and displayed on the dashboard.

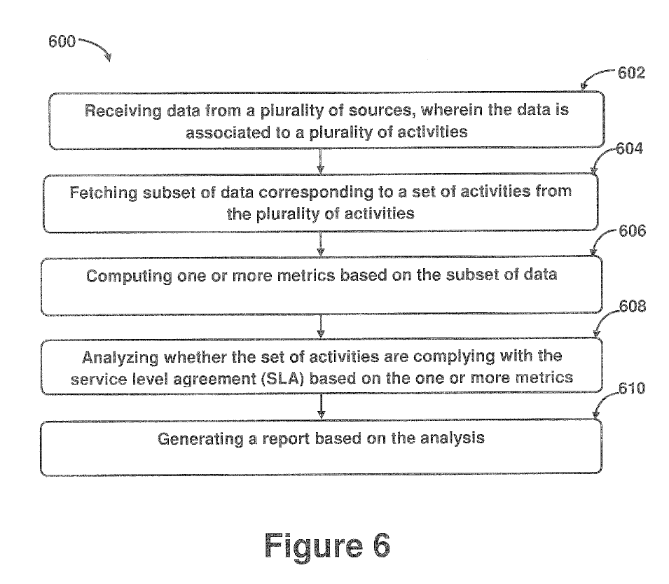

Referring now to FIG. 6, the method of generating a customized report is shown, in accordance with an embodiment of the present subject matter. The method 600 may be described in the general context of computer executable instructions. Generally, computer executable instructions can include routines, programs, objects, components, data structures, procedures, modules, functions, etc., that perform particular functions or implement particular abstract data types. The method 600 may also be practiced in a distributed computing environment where functions are performed by remote processing devices that are linked through a communications network. In a distributed computing environment, computer executable instructions may be located in both local and remote computer storage media, including memory storage devices.

The order in which the method 600 is described is not intended to be construed as a limitation, and any number of the described method blocks can be combined in any order to implement the method 600 or alternate methods. Additionally, individual blocks may be deleted from the method 600 without departing from the spirit and scope of the subject matter described herein. Furthermore, the method can be implemented in any suitable hardware, software, firmware, or combination thereof. However, for ease of explanation, in the embodiments described below, the method 600 may be considered to be implemented in the above described system 102.

At block 602, data from a plurality of sources may be received. The data received may be associated to a plurality of activities being performed corresponding to one or more services defined by a service level agreement (SLA).

At block 604, subset of data may be fetched corresponding to a set of activities, from the plurality of activities, being performed for a predefined time interval.

At block 606, one or more metrics, based on the subset of data, may be computed.

At block 608, it may be analyzed whether the set of activities are complying with the service level agreement (SLA) based on the one or more metrics.

At block 610, a report may be generated based on the analysis discussed in the block 408. Further, the report generated may be customized in a predefined format defined as per the service level agreement (SLA).

Although implementations for methods and systems for generating a customized report have been described in language specific to structural features and/or methods, it is to be understood that the appended claims are not necessarily limited to the specific features or methods described. Rather, the specific features and methods are disclosed as examples of implementations for generating the customized report.

We claim:

1. A method for generating a customized report, wherein the method comprising:
receiving, by a processor, data 226 from a plurality of sources 302, wherein the data 226 is associated to a plurality of activities being performed corresponding to one or more services defined by a service level agreement (SLA);
fetching, by the processor, subset of data corresponding to a set of activities, from the plurality of activities, being performed for a predefined time interval;
computing, by the processor, one or more metrics based on the subset of data;
analyzing, by the processor, whether the set of activities are complying with the service level agreement (SLA) based on the one or more metrics; and
generating, by the processor, a report based on the analysis, wherein the report generated is customized in a predefined format defined as per the service level agreement (SLA).

2. The method of claim 1, wherein the plurality of sources 302 comprises ticketing tools 302-A, monitoring systems 302-B and other sources 302-C.

3. The method of claim 1, wherein the one or more metrics comprises at least one of number of calls received, number of calls abandoned, average speed to answer the calls, average handling time, available time, auxiliary time and service level.

4. The method of claim 1, wherein the report generated comprises:
information pertaining to the one or more metrics upon which the set of activities are performed, and
a priority list of open tickets based on the service level agreement (SLA).

5. The method of claim 1, wherein the report generated is transmitted to a plurality of devices 304, of a plurality of concerned members, associated with the report.

6. The method of claim 5, further comprising customizing the receiving of the data 226 from the plurality of sources 302 based on hardware configuration and software configuration of the plurality of devices 304.

7. A system 102 for generating a customized report, wherein the system 102 comprises:
a processor 202;
a memory 206 coupled with the processor 202, wherein the processor 202 executes a plurality of modules 208 stored in the memory 206, and wherein the plurality of modules 208 comprises:
a receiving module 210 to receive data 226 from a plurality of sources 302, wherein the data 226 is associated to a plurality of activities being performed corresponding to one or more services defined by a service level agreement (SLA);
a fetching module 212 to fetch subset of data corresponding to a set of activities, from the plurality of activities, being performed for a predefined time interval;
a computing module 214 to compute one or more metrics based on the subset of data;
an analyzing module 216 to analyze whether the set of activities are complying with the service level agreement (SLA) based on the one or more metrics; and
a generating module 218 to generate a report based on the analysis, wherein the report generated is customized in a predefined format defined as per the service level agreement (SLA).

8. The system 102 of claim 7, wherein the one or more metrics comprises at least one of number of calls received, number of calls abandoned, average speed to answer the calls, average handling time, available time, auxiliary time and service level.

9. The system 102 of claim 7, wherein the report generated comprises:
information pertaining to the one or more metrics upon which the set of activities are performed, and
a priority list of open tickets based on the service level agreement (SLA).

10. The system 102 of claim 7, further comprises a transmitting module 220 to transmit the report generated to a plurality of devices 304, of a plurality of concerned members, associated with the report.

11. A non-transitory computer readable medium embodying a program executable in a computing device for generating a customized report, the program comprising:
a program code for receiving data from a plurality of sources, wherein the data is associated to a plurality of activities being performed corresponding to one or more services defined by a service level agreement (S LA);
a program code for fetching subset of data corresponding to a set of activities, from the plurality of activities, being performed for a predefined time interval;
a program code for computing one or more metrics based on the subset of data;
a program code for analyzing whether the set of activities are complying with the service level agreement(SLA) based on the one or more metrics; and
a program code for generating a report based on the analysis, wherein the report generated is customized in a predefined format defined as per the service level agreement (SLA).
